(19) United States
(12) Patent Application Publication
(10) Pub. No.: US 2006/0109242 A1
(43) Pub. Date: May 25, 2006

(54) User interface for impaired users

(76) Inventor: Daniel S. Simpkins, Bethesda, MD (US)

Correspondence Address: POTOMAC PATENT GROUP, PLLC, P. O. BOX 270, FREDERICKSBURG, VA, 22404, US

(21) Appl. No.: 11/282,310

(22) Filed: Nov. 18, 2005

Related U.S. Application Data
(60) Provisional application No. 60/629,738, filed on Nov. 19, 2004.

(51) Int. Cl. G09G 5/00

(52) U.S. Cl. 345/156

(57) ABSTRACT

A user interface for visual browsing of content that is optimal for disabled or impaired people is built around a limited set of actions, e.g., SELECT and BACK, or just SELECT. The rest of the useful information is gathered by the act of pointing. The result is a visual browsing capability that allows impaired people much easier access to content and functionality.

This application claims the benefit of U.S. Provisional Patent Application No. 60/629,738 filed on Nov. 19, 2004, the content of which is incorporated here by reference.

### BACKGROUND

This invention relates generally to user interfaces and associated methods and more specifically to user interfaces and methods tailored to impaired users.

User interfaces are ubiquitous in today's society. Computers, cell phones, fax machines, and televisions, to name just a few products, all employ user interfaces. User interfaces are intended to provide a mechanism for users to easily access and manipulate the, sometimes complex, functionality of the devices that they support.

Of course, users differ in their skill levels and, additionally, some users suffer from disabilities that impair their ability to use conventional user interfaces. Some attempts have been made to try to combine conventional displays and conventional user interfaces to new input devices in order to gain functionality for the disabled.

For example, U.S. Pat. No. 4,973,149 to Hutchinson for “Eye Movement Detector” describes a system for eye movement detection using an infrared (IR) light-emitting diode (LED) and an IR-sensitive video camera. Locations, such as areas of a computer display, at which the eye is gazing may be determined and used to operate the computer.

U.S. Pat. No. 5,440,326 to Quinn for “Gyroscopic Pointer” describes a vertical gyroscope adapted for use as a pointing device for controlling the position of a cursor on the display of a computer. A motor at the core of the gyroscope is suspended by two pairs of orthogonal gimbals from a hand-held controller device and nominally oriented with its spin axis vertical by a pendulous device. Electro-optical shaft angle encoders sense the orientation of the hand-held controller device as it is manipulated by a user, and the resulting electrical output is converted into a format usable by a computer to control the movement of a cursor on the computer display.

U.S. patent application Ser. No. 10/768,432, corresponding to U.S. Patent Application Publication No. US2005/0125,826, by Hunleth et al. describes a control framework with a zoomable graphical user interface (GUI) for organizing, selecting, and launching media items. Part of that framework involves the design and operation of GUIs with basic building blocks of point, click, scroll, hover, and zoom and associated with media items that can be used with a free-space pointing remote.

U.S. Provisional Patent Application No. 60/612,571 filed on Sep. 23, 2004, by Liberty et al. for “Free Space Pointing Devices and Methods” describes free-space pointing devices and methods for free-space pointing that accurately translate movement of the free-space pointing device into user interface commands, e.g., movement of a cursor on a computer display. The free-space pointing device may include one or more accelerometers and, optionally, one or more rotational sensors for detecting movement of the free-space pointing device.

Even so, there continues to be a need for improving user interfaces, for example for impaired or otherwise differently abled users.

### SUMMARY

A user interface for visual browsing of content that is optimal for disabled or impaired people is built around a limited set of actions, e.g., SELECT and BACK, or just SELECT. The rest of the useful information is gathered by the act of pointing. The result is a visual browsing capability that allows impaired people much easier access to content and functionality.

In accordance with aspects of this invention, there is provided a user interface consisting or consisting essentially of a select function for selecting a user interface element; and a back function for returning to a previously displayed screen of the user interface.

In accordance with further aspects of this invention, there is provided a user interface consisting or consisting essentially of a select function for selecting a user interface element.

In accordance with still further aspects of this invention, there is provided a user interface consisting of a select function for selecting a user interface element; and a tremor compensation function for compensating for a pointing function.

In accordance with yet further aspects of this invention, there is provided a system that includes a pointing function for pointing to one of a plurality of user interface objects displayed on a screen; a select function operable by a user to select the one of the plurality of user interface objects; a back function operable by the user to return to a previously displayed set of user interface objects; and a tremor compensation function for reducing a variation associated with the pointing function caused by hand tremor.

In accordance with further aspects of this invention, there is provided a system consisting of a pointing function for pointing to one of a plurality of user interface objects displayed on a screen; a select function operable by a user to select the one of the plurality of user interface objects; a back function operable by the user to return to a previously displayed set of user interface objects; and a tremor compensation function for reducing a variation associated with the pointing function caused by hand tremor.

In accordance with still further aspects of this invention, there is provided a system consisting essentially of a pointing function for pointing to one of a plurality of user interface objects displayed on a screen; a select function operable by a user to select the one of the plurality of user interface objects; a back function operable by the user to return to a previously displayed set of user interface objects; and a tremor compensation function for reducing a variation associated with the pointing function caused by hand tremor.

### BRIEF DESCRIPTION OF THE DRAWINGS

The various features, objects, and advantages of this invention will be understood by reading this description in conjunction with the accompanying drawings, which illustrate exemplary embodiments of the present invention and in which:

FIG. 1 depicts an exemplary system according to an exemplary embodiment of the present invention;

FIG. 2 depicts an exemplary media system in which exemplary embodiments of the present invention can be implemented;

FIG. 3 depicts a system controller of FIG. 2 in more detail;

FIG. 4 depicts a free-space pointing device;

FIG. 5 depicts sensors in a free-space pointing device;

FIG. 6 depicts a process model that describes the general operation of a free-space pointing device;

FIG. 7 illustrates an exemplary hardware architecture using a free-space pointing device;

FIG. 8 is a state diagram depicting a stationary detection mechanism for a free-space pointing device;

FIG. 9 depicts an operator using an eye movement detector;

FIG. 9A shows a breakaway view of an eye under infrared illumination;

FIG. 10 depicts a coaxially mounted illuminator and camera;

FIG. 11 is a block diagram of software and hardware usable in an eye movement detector;

FIG. 12 is a block diagram of hardware used in an eye movement detector;

FIG. 13 is a flowchart of a method by which a pupil threshold determination and a glint threshold determination can be made;

FIG. 14 is a histogram that may result from FIG. 13;

FIG. 15 is a flowchart of a method of look-point determination;

FIGS. 16-19 depict a graphical user interface for a media system;

FIG. 20 illustrates an exemplary data structure for a graphical user interface;

FIG. 21 illustrates an exemplary set of overlay controls that can be provided on a graphical user interface; and

FIG. 22 illustrates an exemplary framework for implementing a zoomable graphical user interface.

### DETAILED DESCRIPTION

The following description refers to the accompanying drawings. The same reference numbers in different drawings identify the same or similar elements. Also, the following description does not limit the invention. Instead, the scope of the invention is defined by the appended claims.

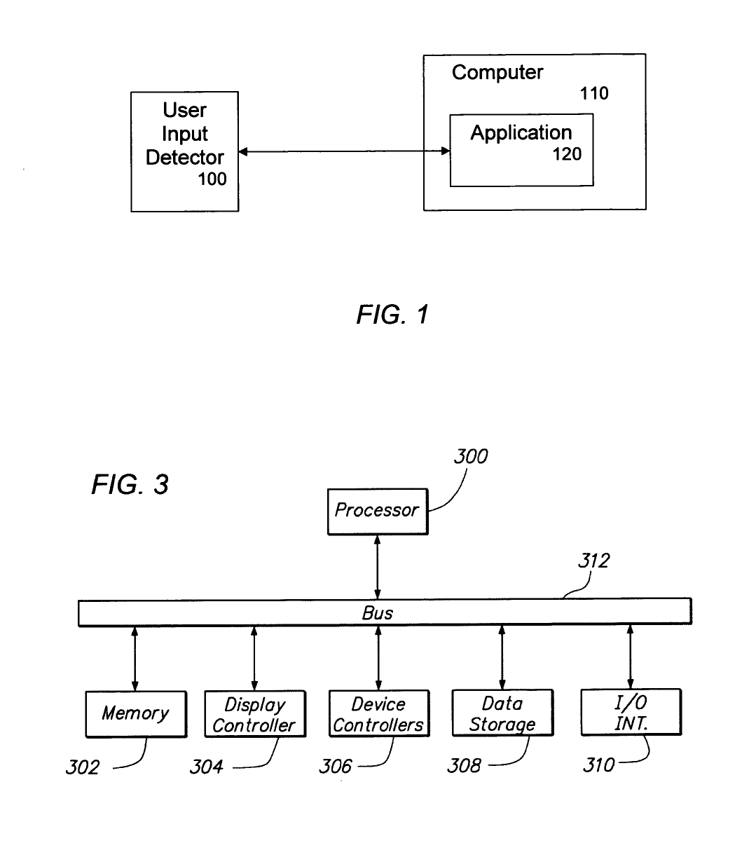

Exemplary embodiments of the present invention provide a visual user interface system which, in a natural way, limits the total number of commands that are possible. This reduced input vocabulary is then the basis for an explicit user interface design around that vocabulary. In order to provide some context for this discussion, an exemplary system in which the present invention can be implemented will first be described with respect to FIG. 1. Those skilled in the art will appreciate, however, that the present invention is not restricted to implementation in this type of system and that more or fewer components can be included therein.

FIG. 1 depicts a user input detector 100 connected to a computer 110 that includes an application 120, which receives input through the interface. According to one exemplary embodiment, the user input detector 100 is a device capable of sensing pointing in some manner and identifying a region or item of interest on the display (not shown) of the computer 110. This user input device could, for example, be a free-space pointer or an eye movement detector or another device that correlates an action of the user to an action of the system, e.g., movement of a cursor on the computer display.

Regardless of the specific type of user input detector 100 that is used in the system, the user input device 100 provides, in addition to POINTING capability, the capability to provide INPUT for the limited vocabulary specified for the user interface. According to one exemplary embodiment of the present invention, the limited vocabulary consists entirely of a SELECT function and a BACK function. The user interface device provides, e.g., one or two buttons or an eye blink detector or a speech recognizer or other input element to provide this functionality. In the same scenario, the computer 110 could be a PC or set-top box, among others, and the application can be a visual browser.

The SELECT function allows the user to select various user interface control elements displayed on the screen. The BACK function enables the user to return to a previously displayed user interface screen. The POINTING function could be performed via eye tracking, in the case of the severely disabled, or via conventional pointing if hand motion is available. The SELECT function could be implemented via speech, pressure, eye blinks, or actual button clicks. This functionality is intentionally simplified to recognize only two commands SELECT and BACK.

According to another exemplary embodiment of the present invention, the system could even be made to work with only the command SELECT and thus enable even easier construction of the command apparatus for the disabled. In this exemplary embodiment, the BACK command can instead be implemented by employing a designated “back” region on the screen that the user selects to return to a previous user interface screen.

For exemplary embodiments in which free-space or other pointing devices are employed as the user input detector 100, tremor compensation can be employed as described in U.S. Provisional Patent Application No. 60/612,571 cited above, the disclosure of which is incorporated here by reference, to provide for a more robust user interface for impaired users by compensating for variations in the act of pointing by a user caused by tremor. An example of an eye movement detector is described in U.S. Pat. No. 4,973,149 cited above, the disclosure of which is also incorporated here by reference. The application 120 can be a user interface application such as that described in U.S. Patent Application Publication No. US 2005/0125826, which corresponds to U.S. patent application Ser. No. 11/029,329 filed on Jan. 5, 2005, which is a continuation of U.S. patent application Ser. No. 10/768,432 filed on Jan. 30, 2004, that is also incorporated here by reference.

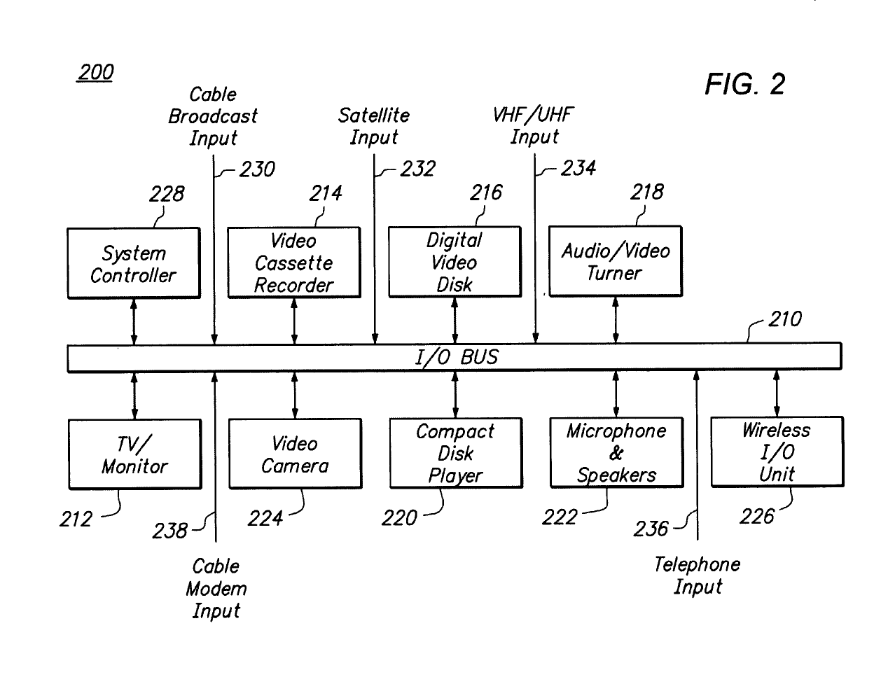

In order to provide some context for this description, an exemplary aggregated media system 200 in which the present invention can be implemented will first be described with respect to FIG. 2. Those skilled in the art will appreciate, however, that this invention is not restricted to implementation in this type of media system and that more or fewer components can be included therein.

The media system 200 may include an input/output (I/O) bus 210 that connects the components in the media system together. The I/O bus 210 represents any of a number of different of mechanisms and techniques for routing signals between the media system components. For example, the I/O bus 210 may include an appropriate number of independent audio “patch” cables that route audio signals, coaxial cables that route video signals, two-wire serial lines or IR or radio frequency (RF) transceivers that route control signals, optical fiber or any other routing mechanisms that route other types of signals.

In this exemplary embodiment, the media system 200 includes a television/monitor 212, a video cassette recorder (VCR) 214, digital video disk (DVD) recorder/playback device 216, audio/video tuner 218, and compact disk (CD) player 220 coupled to the I/O bus 210. The VCR 214, DVD 216, and CD player 220 may be single disk or single cassette devices, or alternatively may be multiple disk or multiple cassette devices. They may be independent units or integrated together. In addition, the media system 200 includes a microphone/speaker system 222, video camera 224, and a wireless I/O control device 226.

The wireless I/O control device 226 may be a media system remote control unit that supports free-space pointing, has a minimal number of buttons to support navigation, and communicates with the entertainment system 200 through RF signals. For example, wireless I/O control device 226 can be a free-space pointing device that uses a gyroscope or other mechanism to define both a screen position and a motion vector to determine the particular command desired. A set of buttons can also be included on the wireless I/O device 226 to initiate a “click” primitive as well as a “back” button. In another exemplary embodiment, wireless I/O control device 226 is a media system remote control unit, which communicates with the components of the entertainment system 200 through IR signals. In yet another embodiment, wireless I/O control device 226 may be an IR remote control device similar in appearance to a typical entertainment system remote control with the added feature of a track-ball or other navigational mechanisms, which allows a user to position a cursor on a display.

The entertainment system 200 also includes a system controller 228, which may operate to store and display entertainment system data available from a plurality of entertainment system data sources and to control a wide variety of features associated with each of the system components. As depicted in FIG. 2, system controller 228 is coupled, either directly or indirectly, to each of the system components, as necessary, through I/O bus 210. In one exemplary embodiment, in addition to or in place of I/O bus 210, system controller 228 is configured with a wireless communication transmitter (or transceiver), which is capable of communicating with the system components via IR signals or RF signals. Regardless of the control medium, the system controller 228 is configured to control the media components of the media system 200 via a GUI described below.

As further illustrated in FIG. 2, media system 200 may be configured to receive media items from various media sources and service providers. In this exemplary embodiment, media system 200 receives media input from and, optionally, sends information to, any or all of the following sources: cable broadcast 230, satellite broadcast 232 (e.g., via a satellite dish), very high frequency (VHF) or ultra high frequency (UHF) radio frequency communication of the broadcast television networks 234 (e.g., via an aerial antenna), telephone network 236, and cable modem 238 (or another source of Internet content). Those skilled in the art will appreciate that the media components and media sources illustrated and described with respect to FIG. 2 are purely exemplary and that media system 200 may include more or fewer of both. For example, other types of inputs to the system include AM/FM radio and satellite radio.

FIG. 3 is a block diagram illustrating an embodiment of an exemplary system controller 228, which can, for example, be implemented as a set-top box and include, for example, a processor 300, memory 302, a display controller 304, other device controllers 306 (e.g., associated with the other components of system 200), one or more data storage devices 308, and an I/O interface 310. These components communicate with the processor 300 via bus 312. Those skilled in the art will appreciate that processor 300 can be implemented using one or more processing units.

Memory device(s) 302 may include, for example, DRAM or SRAM, ROM, some of which may be designated as cache memory, which store software to be run by processor 300 and/or data usable by such programs, including software and/or data associated with the GUIs described below. Display controller 304 is operable by processor 300 to control the display of monitor 212 to, among other things, display GUI screens and objects as described below. Zoomable GUIs provide resolution independent zooming, so that monitor 212 can provide displays at any resolution. Device controllers 306 provide an interface between the other components of the media system 200 and the processor 300. Data storage 308 may include one or more of a hard disk drive, a floppy disk drive, a CD-ROM device, or other mass storage device. Input/output interface 310 may include one or more of a plurality of interfaces including, for example, a keyboard interface, an RF interface, an IR interface and a microphone/speech interface. I/O interface 310 may include an interface for receiving location information associated with movement of a wireless pointing device.

Generation and control of a GUI to display media item selection information is performed by the system controller 228 in response to the processor 300 executing sequences of instructions contained in the memory 302. Such instructions may be read into the memory 302 from other computer-readable media such as data storage device(s) 308 or from a computer connected externally to the media system 200. Execution of the sequences of instructions contained in the memory 302 causes the processor to generate GUI objects and controls, among other things, on monitor 212. In alternative embodiments, hard-wired circuitry may be used in place of or in combination with software instructions. It will be understood that control frameworks described herein overcome limitations of conventional interface frameworks, for example those associated with the television industry. The terms “GUI”, “GUI screen”, “display” and “display screen” are intended to be generic and refer to television displays, computer displays, and any other display device.

As described in the above-incorporated Provisional Patent Application No. 60/612,571, various different types of remote devices can be used as the input device 100, 226, including, for example, trackballs, “mouse”-type pointing devices, light pens, etc., as well as free-space pointing devices. The phrase “free-space pointing” refers to the ability of an input device to move in three (or more) dimensions in the air in front of a display screen, for example, and the corresponding ability of the user interface to translate those motions directly into user interface commands, e.g., movement of a cursor on the display screen. Data can be transferred between the free-space pointing device and the computer or other device either wirelessly or via a wire connecting the free-space pointing device to the other device. Thus “free-space pointing” differs from conventional computer mouse pointing techniques, for example, which use a surface, e.g., a desk surface or mouse pad, as a proxy surface from which relative movement of the mouse is translated into cursor movement on the computer display screen.

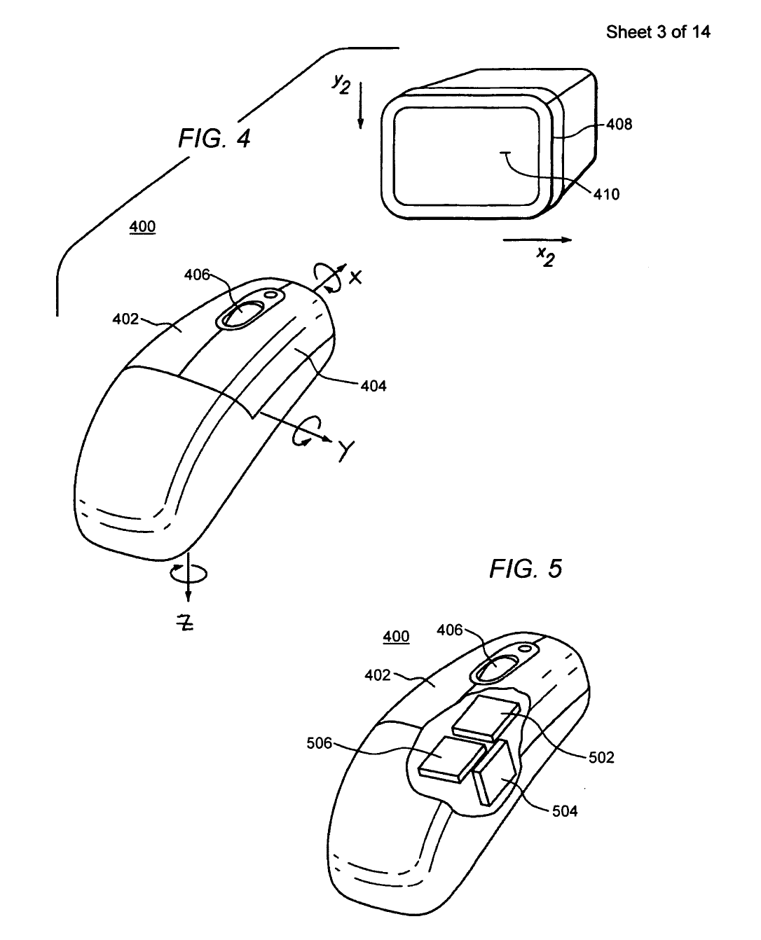

An exemplary free-space pointing device 400 is depicted in FIG. 4. User movement of the free-space pointing device can be defined, for example, in terms of a combination of x-axis attitude (roll), y-axis elevation (pitch) and/or z-axis heading (yaw) motion of the device 400. Linear movement of the pointing device 400 along the x, y, and z axes may also be measured to generate cursor movement or other user interface commands. In the exemplary embodiment depicted in FIG. 4, the free-space pointing device 400 includes two buttons 402, 404 and a scroll wheel 406, although other embodiments can have other physical configurations.

The free-space pointing device 400 may be held by a user in front of a display 408, such as the monitor 212, and motion of the pointing device 400 is translated into output signals that are usable for interaction with information presented on the display 408, e.g., to move a cursor 410 on the display 408. It will be understood that the display 408 may be included in the computer 110 depicted in FIG. 1.

Rotation of the device 400 about the y-axis can be sensed by the device 400, for example, and translated into an output usable by the system to move cursor 410 along the y₂ axis of the display 408. Likewise, rotation of the device 400 about the z-axis can be sensed and translated into an output usable by the system to move cursor 410 along the x₂ axis of the display 408. It will be appreciated that the output of pointing device 400 can be used to interact with the display 408 in a number of ways other than (or in addition to) cursor movement. For example, the device 400 can control cursor fading or control volume or media transport (play, pause, fast-forward, and rewind) in a system such as the media entertainment system 200. Input commands may also include, for example, a zoom in or zoom out on a particular region of a display. A cursor may or may not be visible. Similarly, rotation of the free-space pointing device 400 sensed about the x-axis of free space pointing device 400 can be used in addition to, or as an alternative to, y-axis and/or z-axis rotation to provide input to a user interface.

Referring to FIG. 5, rotational sensors 502, 504 and an accelerometer 506 can be employed as sensors in the device 400. The sensors 502, 504 can, for example, be ADXRS150 sensors made by Analog Devices, although it will be appreciated by those skilled in the art that other types of rotational sensors can be used and that ADXRS150 sensors are simply illustrative examples. If the rotational sensors 502, 504 have a single sensing axis (as an ADXRS150 sensor does, for example), then they may be mounted in the free-space pointing device 400 such that their sensing axes are aligned with the rotations to be measured, although this is not necessary. In the exemplary embodiment depicted in FIGS. 4 and 5, this means that rotational sensor 502 is mounted such that its sensing axis is parallel to the y-axis and that rotational sensor 504 is mounted such that its sensing axis is parallel to the z-axis as shown.

Measurements and calculations are performed by the device 400 that are used to adjust the outputs of one or more of the sensors 502, 504, 506 and/or as part of the input used by a processor to determine an appropriate output for the user interface based on the outputs of the sensors 502, 504, 506. These measurements and calculations are used to compensate for several factors, such as errors associated with the sensors 502, 504, 506 and the manner in which a user uses the free-space pointing device 400, e.g., linear acceleration, tilt and tremor.

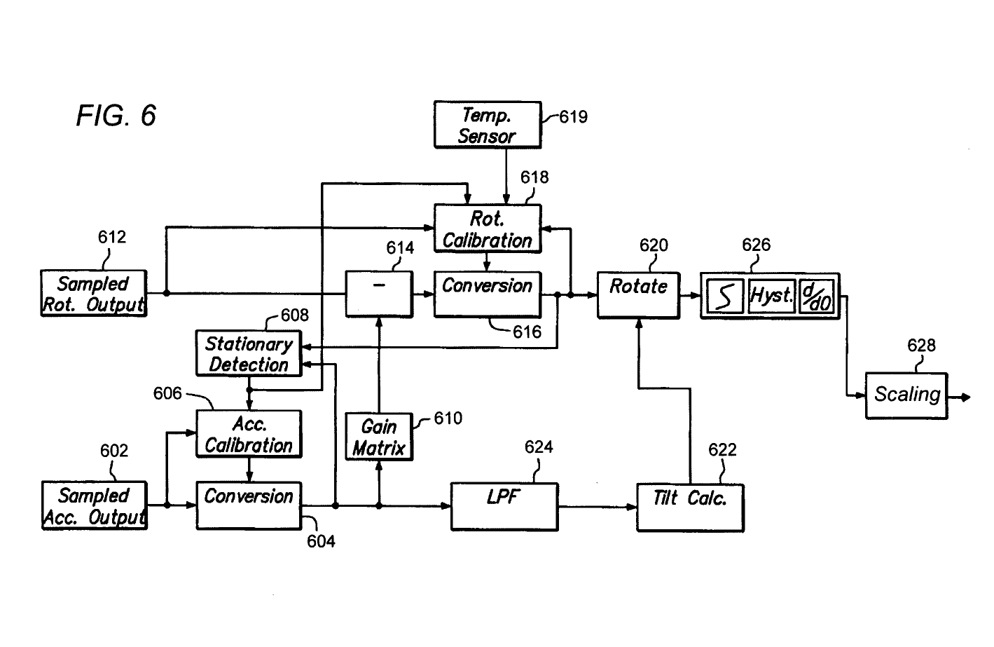

A process model 600 that describes the general operation of a free-space pointing device 400 is illustrated in FIG. 6. The sensors 502, 504, 506 produce analog signals that are sampled periodically, e.g., 200 samples/second. The sampled output from the accelerometer 506 is indicated at block 602, and the sampled output values are converted from raw units to units of acceleration, e.g., gravities (g), as indicated by conversion function 604. An acceleration calibration block 606 provides values used for the conversion function 604. This calibration of the accelerometer output 602 can include, for example, compensation for one or more of scale, offset, and axis misalignment error associated with the accelerometer 506.

The accelerometer 506 may be used to compensate for fluctuations in the readings generated by the rotational sensors 502, 504 that are caused by variances in linear acceleration by multiplying the converted accelerometer readings by a gain matrix 610 and subtracting (or adding) the results from (or to) the corresponding sampled rotational sensor data 612. Similarly, linear acceleration compensation for the sampled rotational data from sensor 504 can be provided at block 614.

Like the accelerometer data, the sampled rotational data 612 is then converted from a sampled unit value into a value associated with a rate of angular rotation, e.g., radians/s, at function 616. This conversion step can also include calibration provided by function 618 to compensate the sampled rotational data for factors such as scale and offset. To accomplish dynamic offset compensation, an input from a temperature sensor 619 may be used in rotation calibration function 618.

After conversion/calibration at block 616, the inputs from the rotational sensors 502, 504 can be further processed to rotate those inputs into an inertial frame of reference, i.e., to compensate for tilt associated with the manner in which the user is holding the free-space pointing device 400, at function 620.

Tilt correction to compensate for a user's holding the pointing device 400 at different x-axis rotational positions can be accomplished by determining the tilt of the device 400 using the inputs y and z received from accelerometer 506 at function 622. After the acceleration data is converted and calibrated as described above, it can be low-pass filtered at LPF 624 to provide an average acceleration value to the tilt determination function 622.

After compensation for linear acceleration, processing into readings indicative of angular rotation of the free-space pointing device 400, and compensation for tilt, post-processing can be performed at blocks 626 and 628 to compensate for factors such as human tremor. Although tremor may be removed using several different methods, one way to remove tremor is by using hysteresis. The angular velocity produced by rotation function 620 is integrated to produce an angular position. Hysteresis of a calibrated magnitude is then applied to the angular position. The derivative is taken of the output of the hysteresis block to again yield an angular velocity. The resulting output is then scaled at function 628 (e.g., based on the sampling period) and used to generate a result within the interface, e.g., movement of the cursor 410 on the display 408.

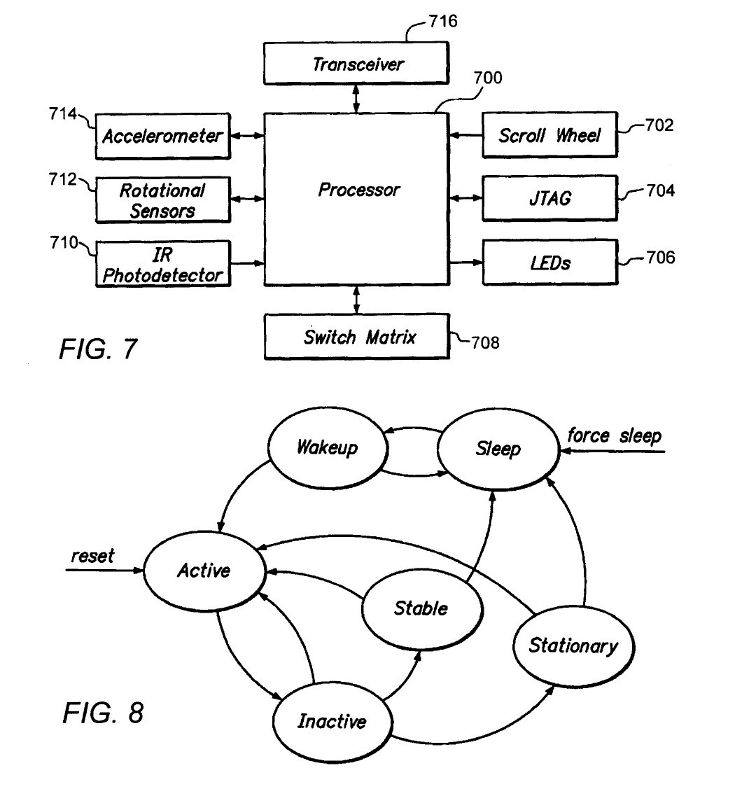

FIG. 7 illustrates an exemplary hardware architecture, including a processor 700 that communicates with other elements of the free-space pointing device 400 including a scroll wheel 702, JTAG 704, LEDs 706, switch matrix 708, IR photodetector 710, rotational sensors 712, accelerometer 714 and transceiver 716. The scroll wheel 702 is an optional input component that enables a user to provide input to the interface by rotating the scroll wheel 702. JTAG 704 provides a programming and debugging interface to the processor. LEDs 706 provide visual feedback to a user, for example, when a button is pressed or a function activated. Switch matrix 708 receives inputs, e.g., indications that a button on the free-space pointing device 400 has been depressed or released, that are then passed on to processor 700. The optional IR photodetector 710 can be provided to enable the exemplary free-space pointing device to learn IR codes from other remote controls.

Rotational sensors 712 provide readings to processor 700 regarding, e.g., the y-axis and z-axis rotation of the free-space pointing device as described above. Accelerometer 714 provides readings to processor 700 regarding the linear acceleration of the free-space pointing device 400 that can be used as described above, e.g., to perform tilt compensation and to compensate for errors which linear acceleration introduces into the rotational readings generated by rotational sensors 712.

Transceiver 716 communicates information to and from free-space pointing device 400, e.g., to a controller in a device such as an entertainment system or to a processor associated with the computer 110. The transceiver 716 can be a wireless transceiver, e.g., operating in accordance with the BLUETOOTH standards for short-range wireless communication or an IR transceiver. Alternatively, free-space pointing device 400 can communicate with systems via a wire-line connection.

Stationary detection function 608 can operate to determine whether the free-space pointing device 400 is, for example, either stationary or active (moving). This categorization can be performed in a number of different ways. One way is to compute the variance of the sampled input data of all inputs (x, y, z, αy, αz) over a predetermined window, e.g., every quarter of a second. αy and αz are rotational data from the sensors 502, 504, respectively. This variance is then compared with a threshold to classify the free-space pointing device as either stationary or active.

By analyzing inputs from the pointing device 400 in the frequency domain, e.g., by performing a Fast Fourier Transform (FFT) and using peak detection, the processor 700 can also determine whether the free-space pointing device 400 is either stationary or active and detect the small movements of the free-space pointing device 400 introduced by a user's hand tremor. Tremor can be identified as peaks in the range of human tremor frequencies, e.g., nominally 8-12 Hz.

Although the variances in the frequency domain can be sensed within a particular frequency range, the actual frequency range to be monitored and used to characterize the status of the free-space pointing device 400 may vary. For example, the nominal tremor frequency range may shift based on, e.g., the ergonomics and weight of the free-space pointing device 200, e.g., from 8-12 Hz to 4-7 Hz.

As mentioned above, tremor data may be memorized as typically each user will exhibit a different tremor pattern. This property of user tremor can also be used to identify users. For example, a user's tremor pattern can be memorized by the system (either stored in the free-space pointing device 400 or transmitted to the system) during an initialization procedure wherein the user is requested to hold the free-space pointing device as steadily as possible for a period, e.g., 10 seconds. This pattern can be used as the user's unique signature to perform a variety of user interface functions. For example, the user interface can identify the user from a group of user's by comparing a current tremor pattern with patterns stored in memory. The identification can then be used, for example, to retrieve preference settings associated with the identified user. For example, if the free-space pointing device is used in conjunction with the media systems described in the above-incorporated by reference patent application, then the media selection item display preferences associated with that user can be activated after the system recognizes the user via tremor pattern comparison. System security can also be implemented using tremor recognition, e.g., access to the system may be forbidden or restricted based on the user identification performed after a user picks up the free-space pointing device 400.

Stationary detection mechanism 608 can include a state machine, an example of which is depicted in FIG. 8. An ACTIVE state is, in the example, the default state during which the free-space pointing device 400 is being used to, e.g., provide inputs to a user interface. The free-space pointing device 400 can enter the ACTIVE state on power-up of the device as indicated by a reset input. If the free-space pointing device 400 stops moving, it may then enter an INACTIVE state. The various state transitions depicted in FIG. 8 can be triggered by any of a number of different criteria including, but not limited to, data output from one or both of the rotational sensors 502 and 504, data output from the accelerometer 506, time domain data, frequency domain data, or any combination thereof.

State transition conditions are generically referred to here using the convention “Condition_{stateA}_{_{→}}_{stateB}”. For example, the free-space pointing device 400 will transition from the ACTIVE state to the INACTIVE state when condition_{active}_{_{→}}_{inactive} occurs. For the sole purpose of illustration, consider that condition_{active}_{_{→}}_{inactive} can, in an exemplary free-space pointing device 400, occur when mean and/or standard deviation values from both the rotational sensor(s) and the accelerometer fall below predetermined threshold values for a predetermined time period.

State transitions can be determined by a number of different conditions based upon the interpreted sensor outputs. Exemplary condition metrics include the variance of the interpreted signals over a time window, the threshold between a reference value and the interpreted signal over a time window, the threshold between a reference value and the filtered interpreted signal over a time window, and the threshold between a reference value and the interpreted signal from a start time. All, or any combination, of these condition metrics can be used to trigger state transitions. Alternatively, other metrics can also be used. A transition from the INACTIVE state to the ACTIVE state may occur either when (1) a mean value of sensor output(s) over a time window is greater than predetermined threshold(s) or (2) a variance of values of sensor output(s) over a time window is greater than predetermined threshold(s) or (3) an instantaneous delta between sensor values is greater than a predetermined threshold.

The INACTIVE state enables the stationary detection mechanism 608 to distinguish between brief pauses during which the free-space pointing device 400 is still being used, e.g., on the order of a tenth of a second, and an actual transition to either a stable or stationary condition. This protects against the functions which are performed during the STABLE and STATIONARY states, described below, from inadvertently being performed when the free-space pointing device is being used. The free-space pointing device 400 will transition back to the ACTIVE state when condition_{inactive}_{_{→}}_{active} occurs, e.g., if the free-space pointing device 400 starts moving again such that the measured outputs from the rotational sensor(s) and the accelerometer exceeds the first threshold before a second predetermined time period in the INACTIVE state elapses.

The free-space pointing device 400 will transition to either the STABLE state or the STATIONARY state after the second predetermined time period elapses. As mentioned earlier, the STABLE state reflects the characterization of the free-space pointing device 400 as being held by a person but being substantially unmoving, while the STATIONARY state reflects a characterization of the free-space pointing device as not being held by a person. Thus, an exemplary state machine can provide for a transition to the STABLE state after a second predetermined time period has elapsed if minimal movement associated with hand tremor is present or, otherwise, transition to the STATIONARY state.

The STABLE and STATIONARY states define times during which the free-space pointing device 400 can perform various functions. For example, since the STABLE state is intended to reflect times when the user is holding the free-space pointing device 400 but is not moving it, the device can record the movement of the free-space pointing device 400 when it is in the STABLE state e.g., by storing outputs from the rotational sensor(s) and/or the accelerometer while in this state. These stored measurements can be used to determine a tremor pattern associated with a particular user or users as described below. Likewise, when in the STATIONARY state, the free-space pointing device 400 can take readings from the rotational sensors and/or the accelerometer for use in compensating for offset.

If the free-space pointing device 400 starts to move while in either the STABLE or STATIONARY state, this can trigger a return to the ACTIVE state. Otherwise, after measurements are taken, the device can transition to the SLEEP state. While in the SLEEP state, the device can enter a power-down mode wherein power consumption of the free-space pointing device is reduced and, e.g., the sampling rate of the rotational sensors and/or the accelerometer is also reduced. The SLEEP state can also be entered via an external command so that the user or another device can command the free-space pointing device 400 to enter the SLEEP state.

Upon receipt of another command, or if the free-space pointing device 400 begins to move, the device can transition from the SLEEP state to the WAKEUP state. Like the INACTIVE state, the WAKEUP state provides an opportunity for the device to confirm that a transition to the ACTIVE state is justified, e.g., that the free-space pointing device 400 was not inadvertently jostled.

The conditions for state transitions may be symmetrical or may differ. Thus, the threshold associated with the condition_{active}_{_{→}}_{inactive} may be the same as (or different from) the threshold(s) associated with the condition_{inactive}_{_{→}}_{active}. This enables free-space pointing devices to capture more accurately user input. For example, exemplary embodiments which include a state machine implementation allow, among other things, for the threshold for transition into a stationary condition to be different from the threshold for the transition out of a stationary condition.

Entering or leaving a state can be used to trigger other device functions as well. For example, the user interface can be powered up based a transition from any state to the ACTIVE state. Conversely, the free-space pointing device and/or the user interface can be turned off (or enter a sleep mode) when the free-space pointing device transitions from ACTIVE or STABLE to STATIONARY or INACTIVE. Alternatively, the cursor 410 can be displayed or removed from the screen based on the transition from or to the stationary state of the free-space pointing device 400.

The STABLE state can be used to memorize tremor data. Typically, each user will exhibit a different tremor pattern. This property of user tremor can also be used to identify users. For example, a user's tremor pattern can be memorized by the system (either stored in the free-space pointing device 400 or transmitted to the system) during an initialization procedure in which the user is requested to hold the free-space pointing device as steadily as possible for, e.g., 10 seconds.

This pattern can be used as the user's unique signature to perform a variety of user interface functions. For example, the user interface can identify the user from a group of user's by comparing a current tremor pattern with those stored in memory. The identification can then be used, for example, to retrieve preference settings associated with the identified user. For example, if the free-space pointing device is used in conjunction with a media system, then the media selection item display preferences associated with that user can be activated after the system recognizes the user via tremor pattern comparison. System security can also be implemented using tremor recognition, e.g., access to the system may be forbidden or restricted based on the user identification performed after a user picks up the free-space pointing device 400.

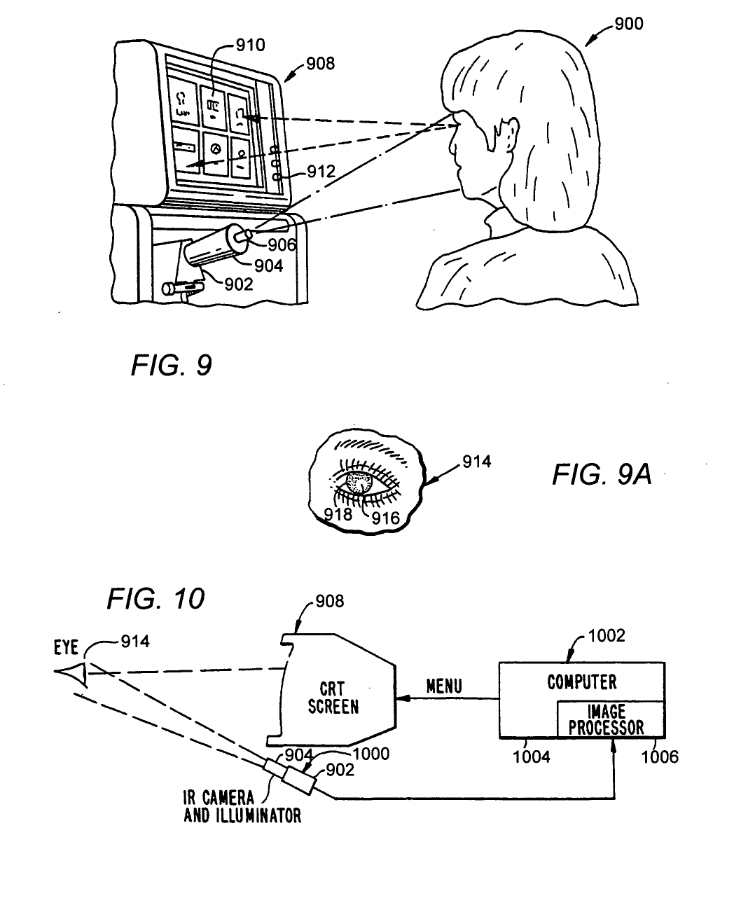

As noted above, an example of an eye movement detector is described in U.S. Pat. No. 4,973,149. Referring to FIG. 9, there is shown an operator 900 utilizing such an eye movement detector. The operator is shown sitting upright such as in a wheelchair but the operator could be lying down through other arrangements or through the use of mirrors in the arrangement shown. In the arrangement shown, there is a camera 902, a camera lens 904 and an IR illuminator 906.

As described in the patent, the illuminator 906 may be a gallium arsenide LED that emits light in the IR region at 880 nanometers but others could also be used in the same range of approximately 900 nanometers such as one that emits light about 905 nanometers. An alternative arrangement for the illumination has four LEDs mounted on a transparent lens cover on the front of lens 904. In this case, the LEDs symmetrically surround the center of the lens and are offset from the center to part way towards the edge of the lens.

As described in the patent, the camera 902 is chosen to be one that is sensitive to the IR region of the light reflected from the eye and face, for example, the Model TN2505A Solid State CID (Charge Injection Device) Surveillance Camera from General Electric Company, Electronics Par 7-G67, Syracuse, N.Y. 13221. The camera 902 is light and small and responds to very low light level in the IR range of the illumination. It also responds to a full range of visible light which is unneeded and is filtered out by a filter mounted preferably at the rear of the camera lens to filter out any light below 800 nanometers. Other cameras or light sensors can be used as long as they are sensitive to the IR region of the illumination at the light levels utilized. The lens used for the camera can be a standard television camera 50 mm 1.4 lens with a diameter of approximately two inches.

Mounted above the camera-lens-illuminator may be a computer display 908, which may be the display 408 seen in FIG. 4, showing six pictures or icons 910. The display may have the normal control knobs 912 for adjusting contrast and so forth. It should be noted in FIG. 9 that the camera-lens-illuminator is located below the computer display and approximately in the horizontal center thereof. Preferably this is 15 to 20 centimeters below the display and midway from the side thereof. This arrangement permits the eye to be illuminated and observed with minimum interference from the eyelid and eyelashes. The illumination is preferably by IR light and FIG. 9 shows the light beam being shot into the eyes and the light reflecting back into the camera lens which through further processing determines the position of the eyes and where they are looking. Staring at one of the areas of interest in the display or an icon or command displayed thereon usually from ½ to 3 seconds, depending on the arrangement in the computer and software and adjusted for the skill of the operator, automatically triggers the system as though the icon or area of interest or command displayed on the screen has a button pressed to close an electrical circuit.

As may be seen more clearly seen in FIG. 10, the IR illuminator and camera lens are coaxially mounted so that the illumination is along the same axis as the axis of the camera and its lens. This serves to outline the pupil of the eye by the “bright eye” effect so that it is brighter than the iris and is therefore easier to distinguish from the remaining parts of the eye. The glint from the surface of the cornea is also picked up and is a brighter image than the pupil.

Coaxial mounting of the LED illumination source 906 with the lens of the camera 902 provides for the illumination to go directly to the eye and return directly down the same path. This provides a “bright eye” effect which is often seen in flash shots in photography when the flashbulb is close to the optical center of the camera. The light enters the pupil and reflects off the retina in the back of the eye and back through the pupil again. This provides a high contrast image between the iris, which is around the pupil, and the pupil itself. Using the “bright eye” effect, the pupil boundary can be seen very clearly. The pupil itself is of a substantially brighter image than the surrounding eye whereas most other times the pupil appears to be the darker part of the eye since the illumination is from off the axis.

Usually the camera is between 60 and 80 centimeters from the head and mounted below the display observed by operator so that it is an underside shot of the face and eyes. This permits the camera to look up underneath the eyebrows and eyelashes and get a better and less obscured view of the eye. The arrangement provides approximately eight to ten inches of lateral movement of the eye and head but only approximately two inches in the z axis or movement to and from the camera. This can be increased with a greater depth of field of focus of the camera lens and illumination arrangement or by rapid automatic focusing of the lens.

FIG. 9A shows a breakaway view of the eye 914 of the operator 900 under IR illumination which shows the glint 916 (slightly enlarged) and the pupil 918 under the “bright eye” effect.

The computer display 908 may be a common colored display with the normal adjustment knobs 912 connected to a computer 110 not shown in FIG. 9. The six screen areas icons or controls 910 shown are represented on areas on the display. While a normal color computer display of the cathode ray tube is used, other suitable displays may be used. It is to be noted that the eye movement detector of FIG. 9 has no attachment to the operator's head but is remote thereto. A closed-circuit image monitor (not shown in FIG. 9) may be provided for making and assuring that the eye is in focus or out of focus in the camera and whether the image of the eye inside this screen is drifting off to the right or to the left.

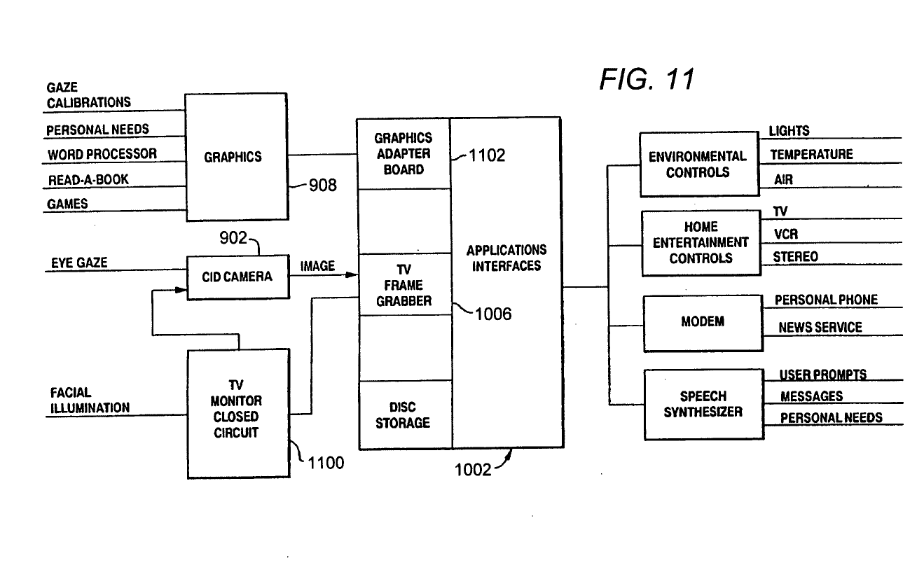

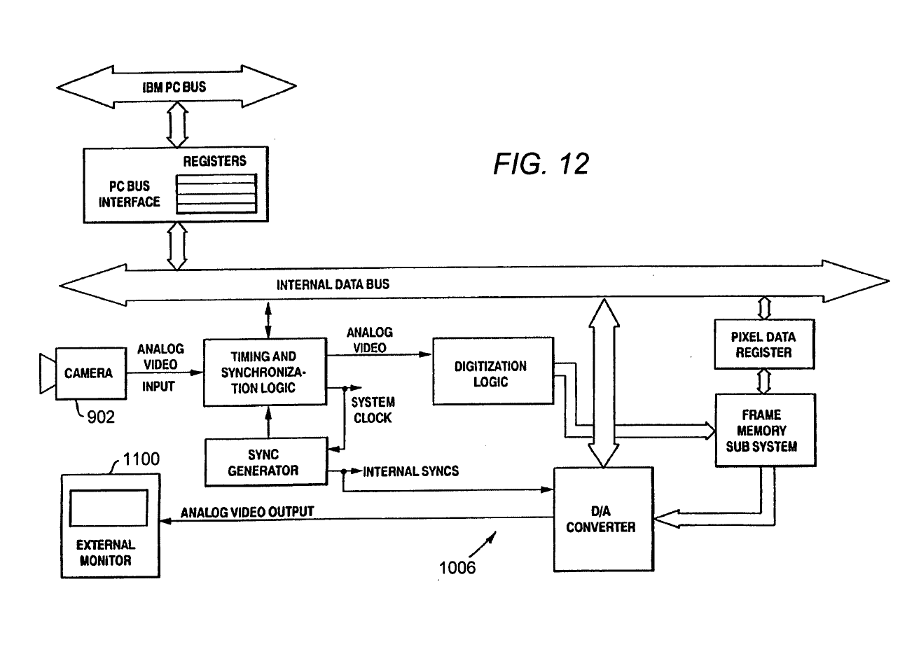

FIG. 10 is a schematic arrangement of the equipment used in the system and shows the eye 914 viewing the computer display or cathode ray tube (CRT) screen 908 under the illumination of IR camera-lens-illuminator assembly 1000. The assembly consists of IR camera 902 and the lens 904 which has on its front the LED illuminator arrangement 906, not specifically shown in FIG. 10. Connected to the camera is a computer and image processor assembly 1002 consisting of a computer 1004 and an image processor 1006, all of which will be more fully described in connection with FIGS. 11 and 12. The computer supplies the menu of scenes or icons or controls to the CRT screen which may be approximately 21.5×25.6 centimeters in size. The display could be a flat panel display rather than a cathode ray tube so long as it properly interfaces with the computer and provides at the proper speed computer generated scenes or icons or controls.

FIG. 11 is an overall block diagram of some of the software and hardware utilizable in the eye movement detector of FIG. 9. In the center section is shown a computer and image processing assembly 1002 which contains the image processor or TV frame grabber 1006 as well as the computer 1004 which is not specifically delineated. There are numerous computers available from many sources that could be utilized. The computer is populated with at least 256K of dynamic random access semiconductor memory and at least 10 megabyte of hard disk storage. The graphics and control files may be stored on this disk. A TV frame grabber or image processor circuit board 44 is placed into the assembly. A suitable board is PCVISION Frame grabber available from Imaging Technology, Inc., 600 West Cummings Park, Woburn, Mass. 01801. The frame grabber is more fully described in connection with FIG. 12.

Facial illumination is supplied to the operator face by the IR source previously described and photographed by the previously described CID videocamera 902. The eye gaze is picked up by the camera which shows in real time on the TV monitor 1100, which is in a closed circuit with the camera, the image being picked up by the CID camera. Also the image is being fed in real time to the TV frame grabber which grabs frames as desired and will be explained more fully below. The computer also contains a graphics adapter board 1102 for interfacing with the graphics display 908 from the computer. Appearing on this computer display 908 are graphics 910 as needed. These graphics or icons or controls include the various menu selections for personal needs, word processing, read-a-book, games as well as other menus which may be developed.

As shown, there may be four major types of applications. They are the environmental control, the home entertainment controls, the modem and the speech synthesizer. Others can be added and all interface through the applications interfaces. The environmental controls can control the lights, temperature and air and other desired environmental controls. The home entertainment controls can control the TV, VCR, stereo, or other desired entertainment features. The modem interfaces for personal phone calls, news services and other data bases over the phone system. The speech synthesizer can furnish user prompts, messages, personal needs and other functions such as calling the nurse as desired.

While FIG. 11 shows both a TV monitor 1100 and graphics display 908, an alternative is for the essential information shown by the TV monitor 1100 to be shown at the periphery of the graphics display 908 so that a separate TV monitor would not be necessary.

FIG. 12 shows a block diagram of some of the hardware usable in an eye movement detector as described in U.S. Pat. No. 4,973,149 with specific emphasis on the image processor or TV frame grabber 1006. This is a sub-system which is used to obtain digitized video frames from the camera and has its own memory. The frame grabber is in the form of a circuit board that can be inserted into an expansion slot of the host computer. A number of such frame grabber boards are available that are capable of use and the description that follows is of the commercial board PCVISION, although it will be understood that a wide variety of devices can be used.

The description is for illustrative purposes only as the technology is generally known. The analog video signal from the camera is inputted into the timing and synchronization logic function which then sends an analog video output signal to digitization logic where the signal is digitized by an analog to digital (A/D) converter that samples at discrete time intervals and digitizes the analog video signal. The digitized output is binary and is sent to the frame memory sub-system where one pixel is stored in each of the memory locations and the storage is organized somewhat like the original camera target except they are digital pixels. This digital information can be sent to the pixel data register and accessed by the host computer through the internal data bus.

The host computer is attached to the internal data bus through the personal computer (PC) bus interface which contains a member of registers which are controlled registers which control the frame grabber by the host computer.

The camera information (images) is run as a closed circuit that is constantly monitored by the monitor. A digital representation of the images is available on-demand for the computer to analyze. This on-demand is referred to as frame grabbing since one of the images or frames is grabbed for computer analysis as the various frames continuously go by on their way through the loop from the camera to the monitor. A particular frame grabbed maps 64 kilobytes of its frame memory into the memory space of the host computer. Since there is a total of 256 kilobytes of frame memory on the grabbed frame, only ¼ of the frame memory is accessible to the host computer at any time.

The video source for the frame grabber can be a standard RS-170 signal. It is composed of analog video information and timing information. The timing information is present between each horizontal scan line. The RS-170 video standard employs an interlacing scheme for displaying as much information as possible in a flicker free manner. With interlacing, the horizontal scan lines of the complete image (called a frame) are divided into two groups called fields. The even field consist of the zero-th (top most), second, fourth and all following even numbered scan lines in the frame. The odd field consist of the first, third, fifth and all remaining odd numbered lines.

When displaying a video image all lines of even field are transmitted in succession, followed by all lines of the odd field with the sequence repeating continuously. The frame grabber acquires and stores an image so that the lines from a pair of successive odd and even fields are merged properly in the frame memory. Even field lines are at even y locations and odd field lines are at odd y locations in the frame memory.

The system timing and synchronization is accomplished by the timing and synchronization and by the system clock. Timing can be extracted from the video signal by a sync stripper which is then passed to a phase locked loop that locks the internal timing of the frame grabber to the video source. If the video signal is lost, the frame grabber automatically switches timing to an internal crystal to avoid the loss of any image data.

The digitization logic is a digital-to-analog converter which converts the analog video signal into a series of digital values, or pixels. This is accomplished by sampling the analog signals at discrete time intervals and converting each individual sample to a digital value. The frame grabber samples the analog signal 10,000,000 times per second. This results in 512 pixels for each horizontal line of the image. The RS-170 standard results in 480 lines of digitized information per frame.

The actual process is accomplished with a flash analog-to-digital converter. The frame grabber digitizes to an accuracy of 6 bits per pixel. Therefore, a maximum of 64 gray levels are possible for each pixel.

The frame grabber memory is organized as an array of 512×512 pixels and provides four bits per pixel. In this configuration, the most significant four bits of the analog-to-digital converter output are stored in the frame memory.

The frame memory is mapped in 64 kilobyte blocks into the memory space of the host computer for direct read/write access. Each of the four 64 kilobytes can be selected individually for direct mapping. The four blocks represent the four quadrants of the frame. By different arrangements, all the quadrants could be simultaneously accessed. The upper right quadrant of the picture from the video camera is usually utilized and must contain the image of the pupil.

The frame memory subsystem simultaneously acquires and displays an image in the monitor. This is accomplished with a read/modify/write cycle on each frame memory. The pixel which is read is transmitted to the display logic for digital-to-analog conversion, and the new pixel from the digitizing logic is written into the memory. Therefore, a one frame lag exists ( 1/30 of a second) when the frame grabber is simultaneously acquiring and displaying an image.

In reading and writing the frame memory, the memory is accessed by the host computer through the bus interface. The 512×512 frame memory is divided into four equally sized segments or blocks which are quadrants of the frame or image. Using one of the registers of the PC Bus Interface, which interfaces the internal data bus with the frame memory subsystem, each of the four segments can be multiplexed into the memory space of the host computer. This is done to limit the amount of host computer address space required by the frame grabber, while maximizing the transfer rate from the frame memory to the host computer memory.

Each pixel in the selected quadrant is individually accessed through the PC Bus Interface. When data is read from or written to the frame memory, the Pixel Data Register is updated. The digital-to-analog (D/A) converter changes the digitized information or image back to an analog format for display on the external monitor.

The SYNC generator generates internal synchronization signals for the frame grabber. Two signals from a sync generator, an internal composite sync and an internal composite blank are input to the digital-to-analog computer. The D/A converter uses the signals to reconstruct an RS-170 signal for input to the external monitor. The 64 kilobyte of digitized graphics information grabbed by the host computer is analyzed by software.

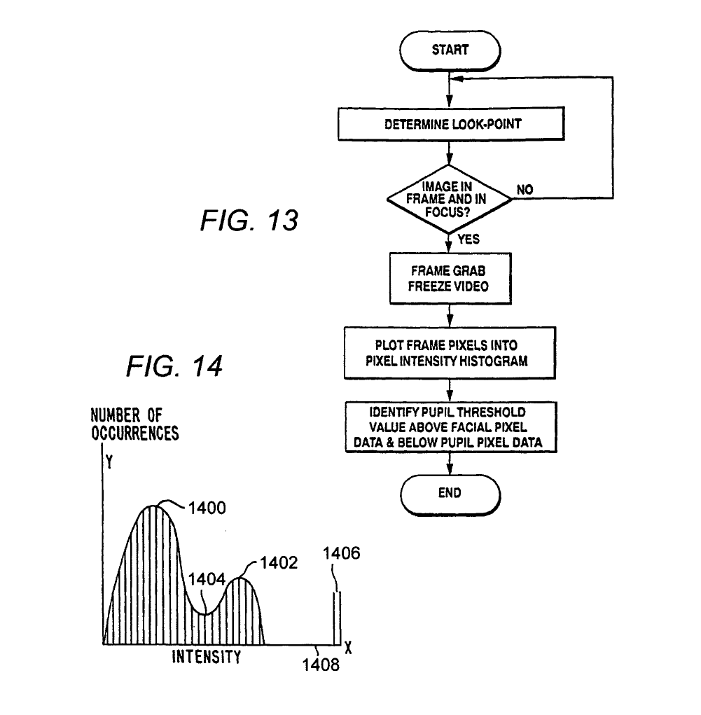

With reference to FIGS. 13 and 14, it can be necessary in the gaze point algorithms to determine the pupil threshold intensity and the glint threshold intensity. These are the intensities of reflected light which are determined that a pixel in a digitized frame that has been grabbed of the eye has an intensity, respectively, just below the intensity of the pupil and just below the intensity of the glint. By utilizing the illumination source mounted coaxially with the camera the pupil has a higher intensity than any other part of the face and eye except for the small glint, which has the greatest intensity of all. The flowchart of FIG. 13 represents the manner by which the pupil threshold determination and the glint threshold determination is made. This is also represented by the histogram of FIG. 14 that may result from the flowchart.

First, it is determined that the look point is such that the eye is in the quadrant of the frame of the camera that will be examined and the image is in the frame. If it is determined that the eye is not in the frame and in focus, another look point is obtained and a determination made of focus and presence. If the image or eye is in the frame and in focus, the frame is grabbed to freeze the video frame in digitized form for processing by the computer as described earlier.

The frame that is grabbed is plotted as to the intensity of each individual pixel into a pixel intensity histogram. This is best seen in FIG. 14, in which the intensity of the light of each pixel is on the x axis and the number of occurrences at that intensity is on the y axis. The histogram actually represents a pictorial representation of the data. The data is not actually plotted to obtain a determination but merely is used to illustrate what the data looks like.

It can be seen from FIG. 14 that the largest amount of data or frequency of occurrences is represented by a lower intensity hump 1400 and a smaller amount of data is represented by a higher intensity hump 1402. Between the two humps is a low point 1404, which is the pupil threshold value that represents an intensity above the facial pixel intensity data and below the pupil pixel intensity data. As seen on the histogram, there are very high intensity pixels 1406, of which there are only a few occurrences. This represents the high intensity glint and between the pupil intensity and glint intensity is the determined glint threshold intensity 1408.

The pupil threshold determination 1404 then is the minimum number of occurrences between the two bands represented by the first hump, mostly facial data and the second hump representing the pupil. It is a value above the facial pixel intensity data and below the pupil pixel intensity data. Once the pupil threshold value is determined and the glint value (not specifically shown on the flowchart) is determined or identified, the flowchart of FIG. 13 has been completed. The entire process of determining the pupil threshold is done in a fraction of a second by the computer using this algorithm.

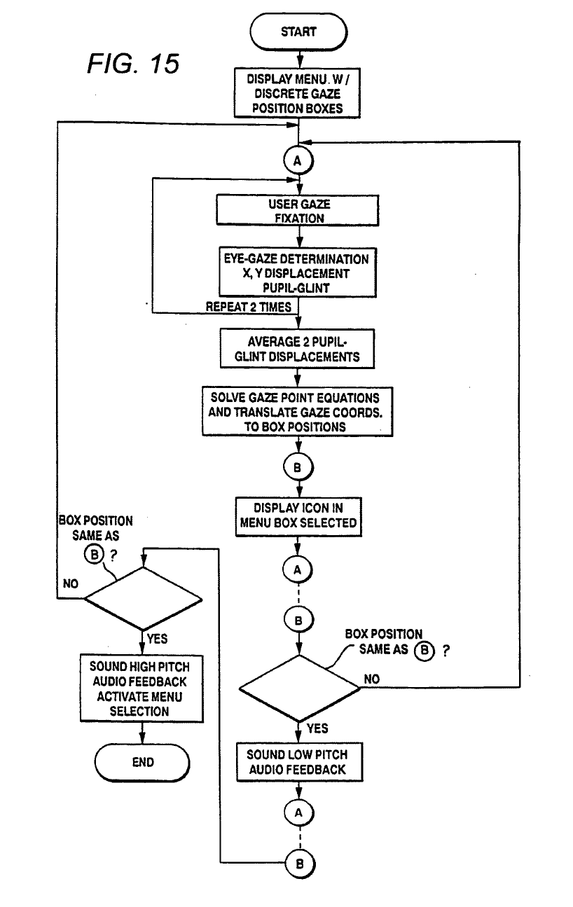

FIG. 15 is a flow chart for look-point determination that uses calibration data and a current gaze to determine where the user is looking at the screen. It starts with the display menu that are at the present time in the form of little boxes 910 that are on the screen where the user would look. The user fixes his gaze on one of the boxes such as six different boxes shown in FIG. 9, holds it there for a sufficient time and the menu is actuated as to the box being viewed. The menu could be in the form of icons, letters of the alphabet and so forth but in all cases represent a discrete area of the display screen upon which the user views for a predetermined period of time to actuate that particular area.

FIG. 15 shows how this is done. The display menu is approached with discrete gaze position boxes. A first user gaze fixation is on a given area, a box on the screen. An eye gaze determination of x, y displacement between the center of the pupil and the glint is made. This is repeated two times and an average of the two pupil-glint displacements is made. For calibration purposes, this may be repeated more than twice, e.g., five times, for several different screen areas, e.g., an area in the upper right of the screen and an area in the lower left of the screen.

Known gaze point equations, for example those described in U.S. Pat. No. 4,973,149, can be solved that translate gaze coordinates to the box positions. Then a display icon in the menu box selected is shown on the screen. At the present time the icon is an x inside a circle. This icon will appear any time that two pupil-glint displacements indicate a sufficient pause that the user may be looking at that part of the screen. The steps between “A” and “B” are repeated. If the box position is the same as “B” before a low pitch audio feed back sound may be made by the computer. If the box position is not the same, then the entire procedure is started over. After the low pitch audio feedback is made, the steps in the flow chart between “A” and “B” are repeated, and again if the box position is the same as “B” earlier, then a high pitch audio feedback sound is made and the menu selected is activated. However, if the box position is not the same the procedure is aborted and the entire procedure starts again.

As noted above, the application 120 can be a user interface application such as that described in U.S. patent application Ser. No. 10/768,432 that describes systems and methods providing a total control framework for organizing, selecting, and launching media items, including a user interface framework that then provides for easy and rapid selection of media items. Control of the framework can employ a free-space pointing device that includes a minimal set of buttons and scroll wheel for pointing, clicking, and scrolling through selections on an associated graphical user interface. This exemplary GUI provides feedback to the user through the use of an on-screen pointer, graphical animations when the pointer hovers over selections, and zooming into and out of selections to smoothly navigate between overview and detail screens. Exemplary embodiments employ images, zooming for increased/decreased levels of detail, and continuity of GUI objects, which permit easy navigation by a user. Such GUIs organize media item selections on a virtual surface. Similar selections can be grouped together. Initially, the interface presents a zoomed out view of the surface, and in most cases, the actual selections will not be visible in full detail at this level. As the user zooms progressively inward, more details are revealed concerning the media item groups or selections. At different zoom levels, different controls are available so that the user can play groups of selections, individual selections, or go to another part of the virtual surface to browse other related media items.

Having described an exemplary media system that can be used to implement control frameworks including zoomable graphical interfaces, an example of such an interface will now be described that displays selectable items that can be grouped by category. A user points a remote unit at the category or categories of interest and depresses the selection button to zoom in or the “back” button to zoom back. Each zoom in, or zoom back, action by a user results in a change in the magnification level and/or context of the selectable items rendered by the user interface on the screen. Each change in magnification level can be consistent, i.e., the changes in magnification level are provided in predetermined steps. The user interface may also incorporate several visual techniques to achieve scaling to the very large that involve a combination of building blocks and techniques that achieve both scalability and ease-of-use, in particular techniques that adapt the user interface to enhance a user's visual memory for rapid re-visiting of user interface objects.

The user interface is largely a visual experience, and in such an environment, uses the ability of the user to remember the location of objects within the visual environment. This is achieved by providing a stable, dependable location for user interface selection items. Each object has a location in the zoomable layout. Once the user has found an object of interest it is natural to remember which direction was taken to locate the object. If that object is of particular interest, it is likely that the user will re-visit the item more than once, which will reinforce the user's memory of the path to the object. User interfaces may provide visual mnemonics that help the user remember the location of items of interest. Such visual mnemonics include pan and zoom animations, transition effects which generate a geographic sense of movement across the user interface's virtual surface and consistent zooming functionality, among other things which will become more apparent based on the examples described below.

Organizing mechanisms are provided to enable the user to select from extremely large sets of items while being shielded from the details associated with large selection sets. Various types of organizing mechanisms can be used in accordance with the present invention and examples are provided below.

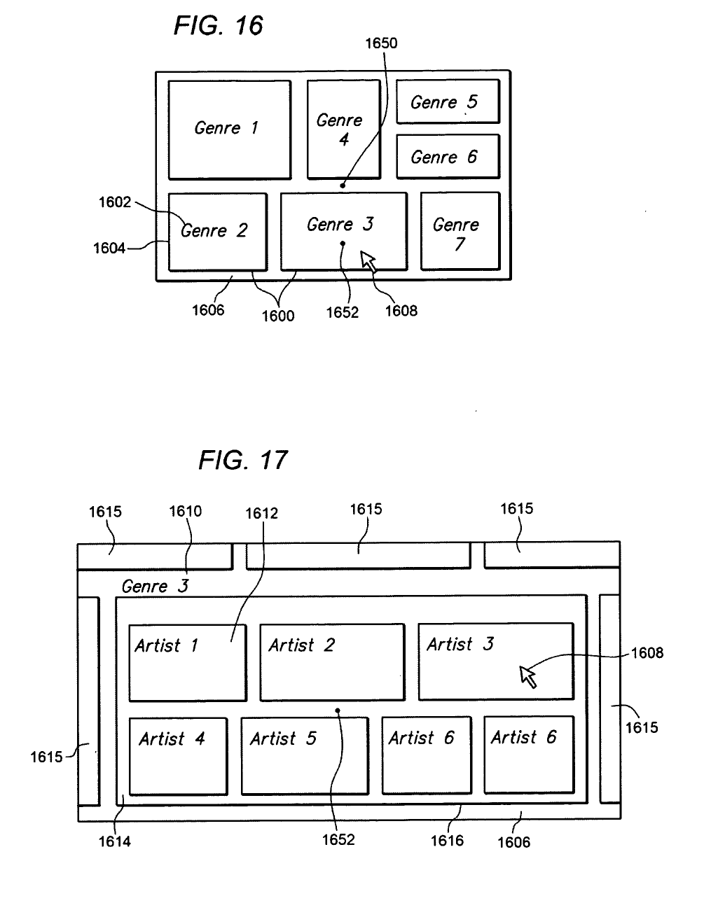

Referring to FIGS. 16-19, an exemplary control framework including a zoomable graphical user interface is described for use in displaying and selecting musical media items. FIG. 16 portrays the zoomable GUI at its most zoomed out state showing a set of shapes 1600. Displayed within each shape 1600 are text 1602 and/or a picture 1604 that describe the group of media item selections accessible via that portion of the GUI.

As shown in FIG. 16, the shapes 1600 are rectangles, and text 1602 and/or picture 1604 describe the genre of the media. Nevertheless, those skilled in the art will appreciate that this first viewed GUI grouping could represent other aspects of selections available to the user, e.g., artist, year produced, area of residence for the artist, length of the item, or any other characteristic of the selection. Also, the shapes used to outline the various groupings in the GUI need not be rectangles. Shrunk-down versions of album covers and other icons could be used to provide further navigational hints to the user in lieu of or in addition to text 1602 and/or picture 1604 within the shape groupings 1600.

A background portion of the GUI 1606 can be displayed as a solid color or be a part of a picture such as a map to aid the user in remembering the spatial location of genres so as to make future uses of the interface require less reading. The selection pointer (cursor) 1608 follows the movements of an input device and indicates the location to zoom in on when the user presses the button on the device (not shown in FIG. 16).

The input device can be a wireless mouse, e.g., the wireless mouse manufactured by Gyration, Inc., Saratoga, Calif. 95070, coupled with a GUI that supports point, click, scroll, hover, and zoom building blocks, which are described in more detail below. One feature of this input device that is beneficial is that it has only two buttons and a scroll wheel, i.e., three input actuation objects. One of the buttons can be configured as a ZOOM IN (select) button and one can be configured as a ZOOM OUT (back) button. Compared with the conventional remote control units, this aspect of the GUI is simplified by greatly reducing the number of buttons, etc., that a user is confronted with in making his or her media item selection.

An additional feature of possible input devices is that they provide free-space pointing capability for the user. Use of free-space pointing in control frameworks further simplifies the user's selection experience, while at the same time providing an opportunity to introduce gestures as distinguishable inputs to the interface. A gesture can be considered as a recognizable pattern of movement over time which pattern can be translated into a GUI command, e.g., a function of movement in the x, y, z, yaw, pitch, and roll dimensions or any sub-combination thereof.

Those skilled in the art will appreciate, however that any suitable input device can be used in conjunction with zoomable GUIs. Other examples of suitable input devices include, but are not limited to, trackballs, touchpads, conventional TV remote control devices, speech input, any devices which can communicate/translate a user's gestures into GUI commands, or any combination thereof. Each aspect of the GUI functionality can be actuated in frameworks using at least one of a gesture and a speech command. Alternate implementations include using cursor and/or other remote control keys or even speech input to identify items for selection.

FIG. 17 shows a zoomed in view of Genre 3 that would be displayed if the user selects Genre 3 from FIG. 16, e.g., by moving the cursor 1608 over the area encompassed by the rectangle surrounding Genre 3 on display 212 and depressing a button on the input device. The interface can animate the zoom from FIG. 16 to FIG. 17 so that it is clear to the user that a zoom occurred. An example of such an animated zoom/transition effect is described below. Once the shape 1616 that contains Genre 3 occupies most of the screen on display 212, the interface reveals the artists that have albums in the genre. In this example, seven different artists and/or their works are displayed.

The unselected genres 1615 that were adjacent to Genre 3 in the zoomed out view of FIG. 16 are still adjacent to Genre 3 in the zoomed in view, but are clipped by the edge of the display 212. These unselected genres can be quickly navigated to by selection of them with selection pointer 1608. It will be appreciated, however, that clipping neighboring objects can be omitted and, instead, only the unclipped selections can be presented. Each of the artist groups, e.g., group 1612, can contain images of shrunk album covers, a picture of the artist or customizable artwork by the user in the case that the category contains play lists created by the user.

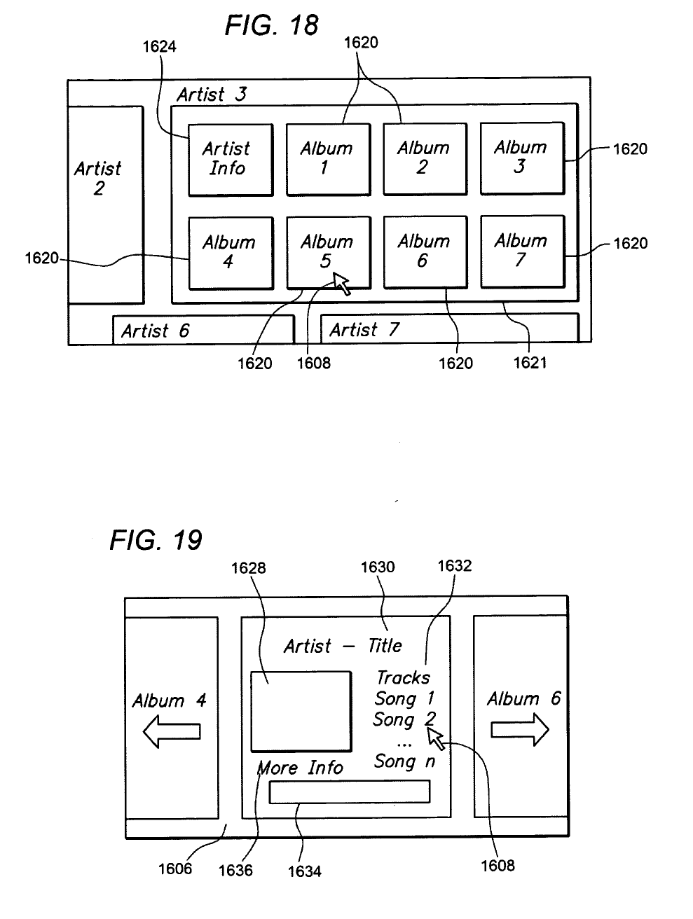

A user may then select one of the artist groups for further review and/or selection. FIG. 18 shows a further zoomed in view in response to a user selection of Artist 3 via positioning of cursor 1608 and actuation of the input device, in which images of album covers 1620 come into view. As with the transition from the GUI screen of FIGS. 16, 17, the unselected, adjacent artists (Artists 2, 6 and 7 in this example) are shown towards the side of the zoomed in display, and the user can click on these with selection pointer 1608 to pan to these artist views. In this portion of the interface, in addition to the images 1620 of album covers, artist information 1624 can be displayed as an item in the artist group. This information may contain, for example, the artist's picture, biography, trivia, discography, influences, links to web sites and other pertinent data. Each of the album images 1620 can contain a picture of the album cover and, optionally, textual data. In the case that the album image 1620 includes a user created play list, the graphical user interface can display a picture that is selected automatically by the interface or preselected by the user.

Finally, when the user selects an album cover image 1620 from within the group 1621, the interface zooms into the album cover as shown in FIG. 19. As the zoom progresses, the album cover can fade or morph into a view that contains items such as the artist and title of the album 1630, a list of tracks 1632, further information about the album 1636, a smaller version of the album cover 1628, and controls 1634 to play back the content, modify the categorization, link to the artists web page, or find any other information about the selection. Neighboring albums 1638 are shown that can be selected using selection pointer 1608 to cause the interface to bring them into view. As mentioned above, the display can zoom in to only the selected object, e.g., album 5, and omit the clipped portions of the unselected objects, e.g., albums 4 and 6. This final zoom provides an example of semantic zooming, in which certain GUI elements are revealed that were not previously visible at the previous zoom level. Various techniques for performing semantic zooming can be provided.

As illustrated in the FIGS. 16-19 and the description, a GUI can provide for navigation of a music collection. It will be understood that the GUI can also be used for video collections such as for DVDs, VHS tapes, other recorded media, video-on-demand, video segments, and home movies. Other audio uses include navigation of radio shows, instructional tapes, historical archives, and sound clip collections. Print or text media, such as news stories and electronic books, can also be organized and accessed using this invention.

As will be apparent to those skilled in the art from the foregoing description, zoomable GUIs provide users with the capability to browse a large (or small) number of items rapidly and easily. This capability is attributable to many characteristics of the interfaces, including, but not limited to: the use of images as all or part of the selection information for a particular media item, the use of zooming to rapidly provide as much or as little information as a user needs to make a selection, and the use of several GUI techniques that combine to give the user the sense that the entire interface resides on a single plane, such that navigation of the GUI can be accomplished, and remembered, by way of the user's sense of direction.

This latter aspect of GUIs can be accomplished by, among other things, linking the various GUI screens together “geographically” by maintaining as much GUI object continuity from one GUI screen to the next, e.g., by displaying edges of neighboring, unselected objects around the border of the current GUI screen. Alternatively, if a cleaner view is desired, and other GUI techniques provide sufficient geographic feedback, then the clipped objects can be omitted. A GUI screen may be rendered on the same display that outputs media items, or it may be rendered on a different display. The display can be a TV display, computer monitor, or any other suitable GUI output device.

Another GUI effect that enhances the user's sense of GUI screen connectivity is the panning animation effect which is invoked when a zoom is performed or when the user selects an adjacent object at the same zoom level as the currently selected object. Returning to the example of FIG. 16, as the user is initially viewing this GUI screen, his or her point-of-view is centered about point 1650, but when he or she selects Genre 3 for zooming in, his or her point-of-view (POV) will shift to point 1652. The zoom in process may be animated to convey the shifting of the POV center from point 1650 to 1652. This panning animation can be provided for every GUI change, e.g., from a change in zoom level or a change from one object to another object on the same GUI zoom level.

Thus, if for example a user situated in the GUI screen of FIG. 17 selected the leftmost unselected genre 1615 (Genre 2), a panning animation would occur that would give the user the visual impression of “moving” left, or west. Such techniques can provide a consistent sense of directional movement between GUI screens, enabling users to more rapidly navigate the GUI, both between zoom levels and between media items at the same zoom level.

Various data structures and algorithms can be used to implement zoomable GUIs. For example, data structures and algorithms for panning and zooming in an image browser which displays photographs have been described, for example, in the article entitled “Quantum Treemaps and Bubblemaps for a Zoomable Image Browser” by Benjamin B. Bederson, UIST 2001, ACM Symposium on User Interface Software and Technology, CHI Letters, 3(2), pp. 71-80, the disclosure of which is incorporated here by reference.

Zoomable GUIs can be conceptualized as supporting panning and zooming around a scene of user interface components in the view port of a display device. To accomplish this effect, zoomable GUIs can be implemented using scene graph data structures. Each node in the scene graph represents some part of a user interface component, such as a button or a text label or a group of interface components. Children of a node represent graphical elements (lines, text, images, etc.) internal to that node. For example, an application can be represented in a scene graph as a node with children for the various graphical elements in its interface. Two special types of nodes are referred to herein as cameras and layers. Cameras are nodes that provide a view port into another part of the scene graph by looking at layer nodes. Under these layer nodes user interface elements can be found. Control logic for a zoomable interface programmatically adjusts a cameras view transform to provide the effect of panning and zooming.

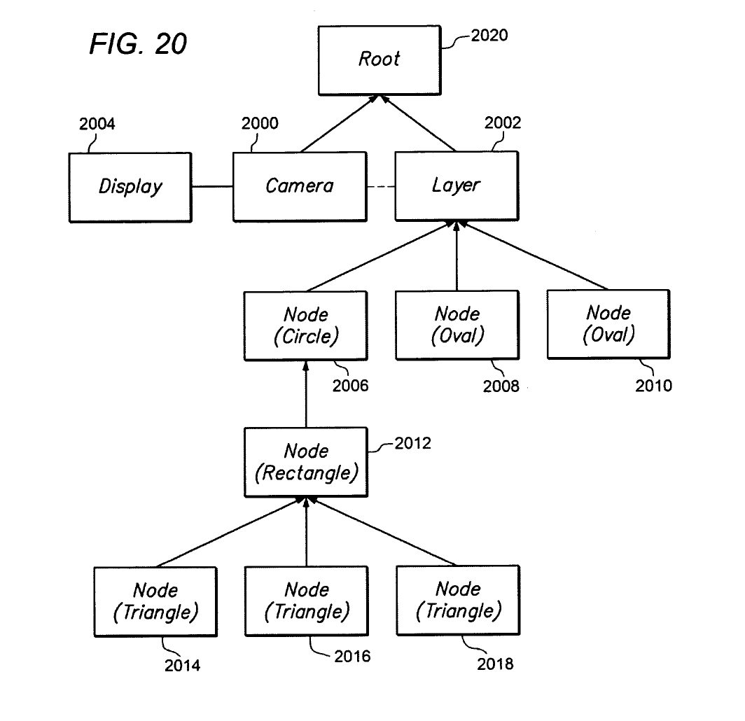

FIG. 20 shows a scene graph that contains basic zoomable interface elements, which can be used to implement a zoomable GUI, including one camera node 2000 and one layer node 2002. The dotted line between the camera node 2000 and layer node 2002 indicates that the camera node 2000 has been configured to render the children of the layer node 2002 in the camera's view port. An attached display device 2004 lets the user see the camera's view port. The layer node 2002 has three children nodes 2004 that draw a circle and a pair of ovals. The scene graph further specifies that a rectangle is drawn within the circle and three triangles within the rectangle by way of nodes 2012-2018. The scene graph is tied into other scene graphs in the data structure by root node 2020. Each node 2006-2018 has the capability of scaling and positioning itself relative to its parent by using a local coordinate transformation matrix.

Rendering the scene graph can be accomplished as follows. Whenever the display 2004 needs to be updated, e.g., when the user triggers a zoom-in, a repaint event calls the camera node 2000 attached to the display 2004 to render itself. This, in turn, causes the camera node 2000 to notify the layer node 2002 to render the area within the camera's view port. The layer node 2002 renders itself by notifying its children to render themselves, and so on. The current transformation matrix and a bounding rectangle for the region to update is passed at each step and optionally modified to inform each node of the proper scale and offset that they should use for rendering. Since the scene graphs of applications operating within zoomable GUIs may contain thousands of nodes, each node can check the transformation matrix and the area to be updated to ensure that their drawing operations will indeed be seen by the user. Although the foregoing example describes a scene graph including one camera node and one layer node, it will be appreciated that multiple cameras and layers can be embedded. These embedded cameras can provide user interface elements such as small zoomed out maps that indicate the user's current view location in the whole zoomable interface, and also allow user interface components to be independently zoomable and pannable.

A computationally efficient node watcher algorithm can be used to notify applications regarding when GUI components and/or applications enter and exit the view of a camera. At a high level, known node watcher algorithms may have three main processing stages: initialization, view port change assessment, and scene graph change assessment. The initialization stage computes node quantities used by the view port change assessment stage and initializes appropriate data structures. The view port change assessment stage gets invoked when the view port changes and notifies all watched nodes that entered or exited the view port. Finally, the scene graph change assessment stage updates computations made at the initialization stage that have become invalid due to changes in the scene graph. For example, if an ancestor node of the watched node changes location in the scene graph, computations made at initialization may need to be recomputed.

Of these stages, view port change assessment may drive the rest of the node watcher algorithm. To delineate when a node enters and exits a view port, the initialization step determines the bounding rectangle of the desired node and transforms it from its local coordinate system to the local coordinate system of the view port. In this way, checking node entrance does not require a sequence of coordinate transformations at each view port change. Since the parents of the node may have transform matrices, this initialization step requires traversing the scene graph from the node up to the camera. If embedded cameras are used in the scene graph data structure, then multiple bounding rectangles may be needed to accommodate the node appearing in multiple places.

Once the bounding rectangle for each watched node has been computed in the view port coordinate system, the initialization stage adds the bounding rectangle to the view port change assessment data structures. The node watcher algorithm uses a basic building block for each dimension in the scene. In some zoomable interfaces, this includes an x dimension, a y dimension, and a scale dimension, but other implementations may have additional or different dimensions. The scale dimension describes the magnification level of the node in the view port and is described by the following equation:

$$s = \frac{{d}^{′}}{d}$$

where s is the scale, d is the distance from one point of the node to another in the node's local coordinates, and d′ is the distance from that point to the other in the view port.

In addition to using node watcher notifications for application memory management, this algorithm can also be used for other functions in zoomable GUIs. For example, the node watcher algorithm can be used to change application behavior based on the user's view focus, e.g., by switching the audio output focus to the currently viewed application. Another application for the node watcher algorithm is to load and unload higher resolution and composite images when the magnification level changes. This reduces the computational load on the graphics renderer by having it render fewer objects whose resolution more closely matches the display. In addition to having the node watcher algorithm watch a camera's view port, it is also useful to have it watch the navigation code that tells the view port where it will end up after an animation. This provides earlier notification of components that are going to come into view and also enables a zoomable GUI to avoid sending notifications to nodes that are flown over due to panning animations.

In addition to the node watcher algorithm described above, resolution-consistent semantic zooming algorithms can be used in a zoomable GUI. Semantic zooming refers to adding, removing, or changing details of a component in a zoomable GUI depending on the magnification level of that component. For example, when a user zooms close enough to an item, such as the image of a movie, the item changes to show item metadata and controls, such as playback controls. The calculation of the magnification level is based on the number of pixels that the component uses on the display device. The zoomable GUI can store a threshold magnification level that indicates when the switch should occur, e.g., from a view without the metadata and controls to a view with the metadata and controls.

Television and computer displays have widely varying display resolutions. Some monitors have such a high resolution that graphics and text that is readable on a low resolution display is so small to become completely unreadable. This also creates a problem for applications that use semantic zooming, especially on high resolution displays such as high-definition televisions (HDTVs). In this environment, semantic zooming code that renders based on the number of pixels displayed will change the image before the more detailed view is readable. Programmatically modifying the threshold at which semantic zooming changes component views can only work for one resolution.

The desirable result is that semantic zooming occurs consistently across all monitor resolutions. One solution is to use lower resolution display modes on high-resolution monitors, so that the resolution is identical on all displays, but the user of a high-resolution monitor would prefer that graphics would be rendered at their best resolution if semantic zooming would still work as expected. Accordingly, the semantic zooming technique should support displays of different solutions without the previously stated semantic viewing issues. This can be accomplished by, for example, creating a virtual display inside the scene graph in a known way.

The node watcher algorithm described above can also be used to aid in the transition between the zoom level depicted in a GUI screen. The rendering of GUI screens containing text and/or control elements that are not visible in other zoom level versions of the selected image may be more computationally and/or memory intensive than the images at lower magnification levels. Accordingly, the node watcher algorithm can be used to aid in pre-loading of GUI screens by watching the navigation code of the GUI to more rapidly identify the particular item being zoomed in on.

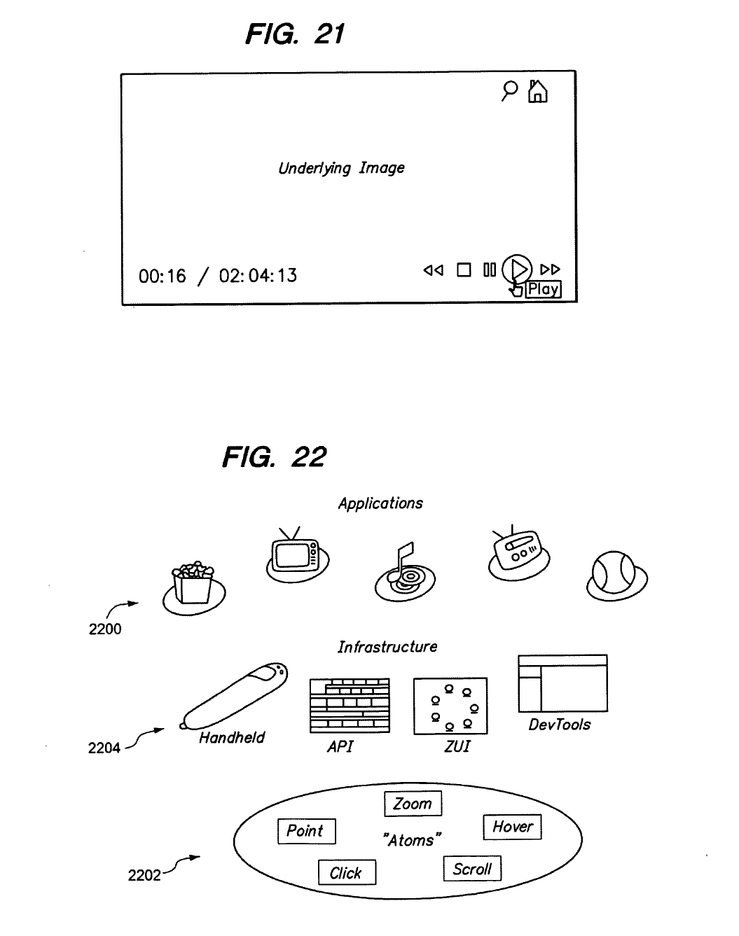

Screen-location and semantically-based navigation controls control regions that appear when the user positions the cursor near or in a region associated with those controls on a screen where those controls are appropriate as shown in FIG. 21. For example, when playing a movie, the so-called trick functions of Fast Forward, Rewind, Pause, Stop, and so on are semantically appropriate. A screen region assigned to those functions may be the lower right corner as depicted in FIG. 21, and when the cursor is positioned near or in that region, the set of icons for those trick functions appear. These icons then disappear when the function engaged is clearly completed or when the cursor is positioned elsewhere on the screen.

The same techniques can also be used to cover other navigational features like text search and home screen selection. These controls are semantically relevant on all screens and the region assigned to them can be the upper right corner. When the cursor is positioned near or in that region, the set of icons for those navigational controls appear. These icons then disappear when the function is activated or the cursor is positioned elsewhere on the screen. Note that for user training purposes, the relevant control icons may initially optionally appear briefly (e.g., 5 seconds) on some or all of the relevant screens in order to alert the inexperienced user to their presence.

Having provided some examples of zoomable GUIs, exemplary frameworks and infrastructures for using such interfaces will now be described. FIG. 22 provides a framework diagram in which zoomable interfaces associated with various high-level applications 2200, e.g., movies, television, music, radio and sports, are supported by primitives 2202 (referred to in FIG. 22 as “atoms”). Primitives 2202 may include POINT, CLICK, ZOOM, HOVER, and SCROLL, although those skilled in the art will appreciate that other primitives may be included in this group as well, e.g., PAN and DRAG.

The POINT and CLICK primitives can operate to determine cursor location and trigger an event when, for example, a user actuates the ZOOM IN or ZOOM OUT button on the input device. These primitives simplify navigation and remove the need for repeated up-down-right-left button actions. As illustrated above, the ZOOM primitive provides an overview of possible selections and gives the user context when narrowing his or her choices. This concept enables the interface to scale to large numbers of media selections and arbitrary display sizes. The SCROLL primitive handles input from the scroll wheel input device on the exemplary handheld input device and can be used to, for example, accelerate linear menu navigation. The HOVER primitive dynamically enlarges the selections underneath the pointer (and/or changes the content of the selection) to enable the user to browse potential choices without committing.

Each of the primitive operations can be actuated in GUIs in a number of different ways. For example, each of POINT, CLICK, HOVER, SCROLL, and ZOOM can be associated with a different gesture performed by a user. The gesture can be communicated to the system via the input device, whether it be a free-space pointer, eye movement detector, trackball, touchpad, etc., and translated into an actuation of the appropriate primitive. Likewise, each of the primitives can be associated with a respective voice command.

Between the lower-level primitives 2202 and the upper-level applications 2200 reside various software and hardware infrastructures 2204 that are involved in generating the images associated with the GUI. As seen in FIG. 22, such infrastructures 2204 can include a handheld input device/pointer, application program interfaces (APIs), GUI screens, developers' tools, etc.

The present invention provides a new user interface for visual browsing of content that is optimal for disabled or impaired people. The entire user interface is built around a limited set of actions, e.g., SELECT and BACK, or just SELECT. The rest of the useful information is gathered by the act of pointing. The result is a new visual browsing capability that allows impaired people much easier access to content and functionality.

The above-described exemplary embodiments are intended to be illustrative in all respects, rather than restrictive, of the present invention. The present invention is capable of many variations in detailed implementation that can be derived from this description by a person skilled in the art. All such variations and modifications are considered to be within the scope and spirit of the present invention as defined by the following claims. No element, act, or instruction used in this description should be construed as essential to the invention unless explicitly described as such. Also, as used herein, the article “a” is intended to include one or more items.

What is claimed is:

1. A user interface consisting of:
a select function for selecting a user interface element; and
a back function for returning to a previously displayed screen of the user interface.

2. The user interface of claim 1, further consisting of a tremor compensation function for compensating for a pointing function.

3. A user interface consisting essentially of:
a select function for selecting a user interface element; and
a back function for returning to a previously displayed screen of the user interface.

4. The user interface of claim 3, further consisting essentially of a tremor compensation function for compensating for a pointing function.

5. A user interface consisting of:
a select function for selecting a user interface element.

6. A user interface consisting essentially of:
a select function for selecting a user interface element.

7. A user interface consisting of:
a select function for selecting a user interface element; and
a tremor compensation function for compensating for a pointing function.

8. A user interface consisting essentially of:
a select function for selecting a user interface element; and
a tremor compensation function for compensating for a pointing function.

9. A system comprising:
a pointing function for pointing to one of a plurality of user interface objects displayed on a screen;
a select function operable by a user to select the one of the plurality of user interface objects;
a back function operable by the user to return to a previously displayed set of user interface objects; and
a tremor compensation function for reducing a variation associated with the pointing function caused by hand tremor.

10. A system consisting of:
a pointing function for pointing to one of a plurality of user interface objects displayed on a screen;
a select function operable by a user to select the one of the plurality of user interface objects;
a back function operable by the user to return to a previously displayed set of user interface objects; and
a tremor compensation function for reducing a variation associated with the pointing function caused by hand tremor.

11. A system consisting essentially of:
a pointing function for pointing to one of a plurality of user interface objects displayed on a screen;
a select function operable by a user to select the one of the plurality of user interface objects;
a back function operable by the user to return to a previously displayed set of user interface objects; and
a tremor compensation function for reducing a variation associated with the pointing function caused by hand tremor.
